(19) United States
(12) Patent Application Publication
(10) Pub. No.: US 2002/0133469 A1
(43) Pub. Date: Sep. 19, 2002

(54) Electronic mail filtering system

(76) Inventor: Charles M. Patton, Eugene, OR (US)

Correspondence Address: HEWLETT-PACKARD COMPANY, Intellectual Property Administration, P.O. Box 272400, Fort Collins, CO, 80527-2400, US

(21) Appl. No.: 09/812,493

(22) Filed: Mar. 19, 2001

(51) Int. Cl. G06F 17/60

(52) U.S. Cl. 705/75; 709/318

(57) ABSTRACT

A system that filters e-mail is comprised of a clearinghouse that processes a check attached to the e-mail. The check is made out to the intended recipient with an expiration date and a transaction identification. The clearinghouse verifies the signature of the sender, the validity date of the check, tracks the transaction identification to verify it is unique, verifies the sufficiency of the sender's account, and institutes a hold on the account equal to the amount of the check. The clearinghouse generates a status of the check that is sent with the e-mail and check to the recipient's Internet service provider. The Internet service provider, based on the status, either sends the check to the intended recipient or back to the sender.

### TECHNICAL FIELD

The present invention relates generally to electronic mail. More particularly, the present invention relates to the filtering of electronic mail.

### BACKGROUND OF THE INVENTION

The volume of unsolicited e-mails, referred to as “spam”, is rapidly increasing. Marketers are using various means to obtain individuals' e-mail addresses in order to either target market products and services or even to broadcast products and services to a general population.

Efforts to combat the proliferation of spam are also increasing. Most e-mail clients include filtering options that may filter out some of the unwanted e-mails. Additionally, individuals and anti-spam organizations are using legal means to force some marketers to stop transmitting the unsolicited e-mails.

Attempts to filter out spam using e-mail client filters have not been successful. The filters tend to remove only the e-mails that have a sender address corresponding to a known marketer. New marketers are appearing that the e-mail client must track and constantly add the new sender addresses. Also, some marketers go through different servers on the Internet to disguise their address such that the e-mail filter does not recognize it as a known offender.

Additionally, many people are searching for a way to start an “attention economy” rather than an “ownership economy” wherein the most valuable asset that is traded is a person's attention. There is a resulting unforeseen need for a process to filter out unsolicited e-mails more reliably as well as jumpstart an attention economy.

### SUMMARY OF THE INVENTION

The present invention encompasses a process for filtering a communication in a communications system. In the preferred embodiment, the communications system is an e-mail system and the process filters the e-mails received by an intended recipient.

The process specifies a requirement for a predetermined value to be attached to the e-mail that is transmitted by a sender to the intended recipient. In the preferred embodiment, this value is a check that is made out for the required amount that the recipient has designated. If the e-mail comprises a check for the predetermined value, the e-mail is forwarded to the recipient for his evaluation.

In a preferred embodiment, the e-mail is processed by the recipient's e-mail service provider to determine the sufficiency of the value, the expiration date, that the check is made out to the intended recipient, which clearinghouse to use and then requests a hold through the clearinghouse. The e-mail with the check is then sent to the clearinghouse for further processing.

The clearinghouse verifies the signature of the sender, the validity date, that the transaction identification is unique, and the sufficiency of the sender's account upon which the check is drawn. The clearinghouse then institutes a hold on the sender's account.

The recipient's e-mail service provider receives the status of the hold and forwards the e-mail to the recipient's e-mail client or back to the sender, depending on the status of the hold. If the recipient's e-mail client gets the e-mail, the client countersigns the check and sends it to the clearinghouse for verification of the countersignature. The clearinghouse then either transfers the value to the recipient's designated account or releases the hold.

### BRIEF DESCRIPTION OF THE DRAWINGS

FIG. 1 shows a flowchart of a process for an e-mail sender to transmit an e-mail in accordance with the present invention.

FIG. 2 shows a flowchart of a process for a recipient's Internet service provider to filter a received e-mail in accordance with the present invention.

FIG. 3 shows a flowchart of a process for an e-mail clearinghouse to provide a status check of an attached check in accordance with the present invention.

FIG. 4 shows a flowchart of a process for the recipient's Internet service provider to react to the status of the attached check.

FIG. 5 shows a flowchart of a process used by an e-mail recipient in accordance with the present invention.

FIG. 6 shows a flowchart of a process for the e-mail clearinghouse to react to the e-mail recipient's actions in accordance with the present invention.

FIG. 7 shows a block diagram of an e-mail filtration system of the present invention.

FIG. 8 illustrates a block diagram of a computer server in accordance with the system of FIG. 7.

FIG. 9 shows a flowchart of a process for an e-mail sender to automatically respond to a “bounced” e-mail in accordance with the present invention.

### DETAILED DESCRIPTION OF THE PREFERRED EMBODIMENT

The system and processes of the present invention provide a reliable filtration of unsolicited e-mails. As an additional benefit, the present invention provides a way to encourage an attention-based economy.

The present invention uses a “check” attached to an e-mail to provide an incentive for a recipient to read the e-mail. The check also reduces the chances that a marketer will send an unsolicited e-mail since it will cost the marketer a recipient-specified amount of value before the recipient will read the e-mail. This has the potential to cost the marketer a very large amount in order to mass-market products or services.

The subsequent description of the present invention refers to “checks” as being attached to the e-mails. In one embodiment, these checks are electronic versions of the paper checks used in everyday transactions that cause a form of currency to be transferred from the check signer to the check recipient. This type of service is similar to the Internet services used to transact business through an electronic commerce website such as EBAY. For example, one company allows both the seller and the purchaser to establish accounts so that the purchaser can transfer money to the seller through the company.

However, in alternate embodiments, the term “check” refers to other forms of value. As an example of one form of value, the signer and recipient may have accounts of credits that can be used or traded. The “check” may be worth 250 credits that, when transferred to the recipient's credit account, allows the recipient to go on-line and use the credits to purchase items from vendors that deal in such credits.

Other embodiments use anything that is of value to both the signer and the recipient. These different forms of value include time for using a desired service (e.g., on-line time) or items of value (e.g., art and software) or any other service or thing of value that can be traded.

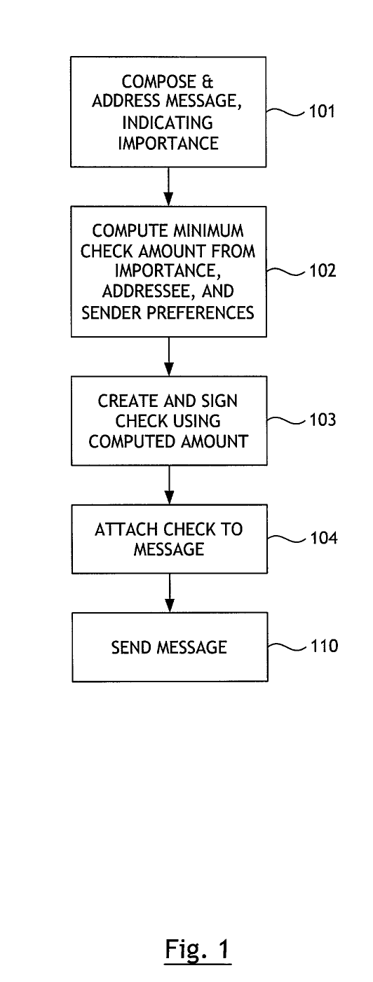

The process begins with the e-mail sender process illustrated in FIG. 1. The sender composes and addresses the e-mail to the desired recipient (step 101) using an e-mail client. One example of such an e-mail client is EUDORA by QUALCOMM, INC. The e-mail clients are well known in the art and are not discussed further.

The sender may set up a minimum and maximum value to be attached as a function of the addressee, sender preferences, and indicated importance of the message (step 102). When the message is first sent, the minimum value is used. If the recipient indicates that this is insufficient, the amount may be automatically adjusted up to the sender's indicated maximum value.

The sender then creates and digitally signs the check using the computed amount (step 103). The check is attached to the e-mail (step 104) and transmitted to the intended recipient (step 110) using the sender's Internet service provider. The process of sending e-mails is well known in the art and is not discussed further.

The check is made out to the intended recipient so that only that person can cash the check. If the e-mail is intercepted by another party, the check would be useless to the unintended receiver.

In order for the sender to know the amount of value that the recipient requires in the check such that the recipient will accept the e-mail, the sender and recipient can agree prior to the e-mail on the amount. Additionally, the recipient can list his required amount with a public service, bulletin board, or at the clearinghouse (discussed subsequently) that are all accessible to any sender desiring to send e-mails to that particular recipient. The form of value that is acceptable to the recipient may also be listed along with the amount.

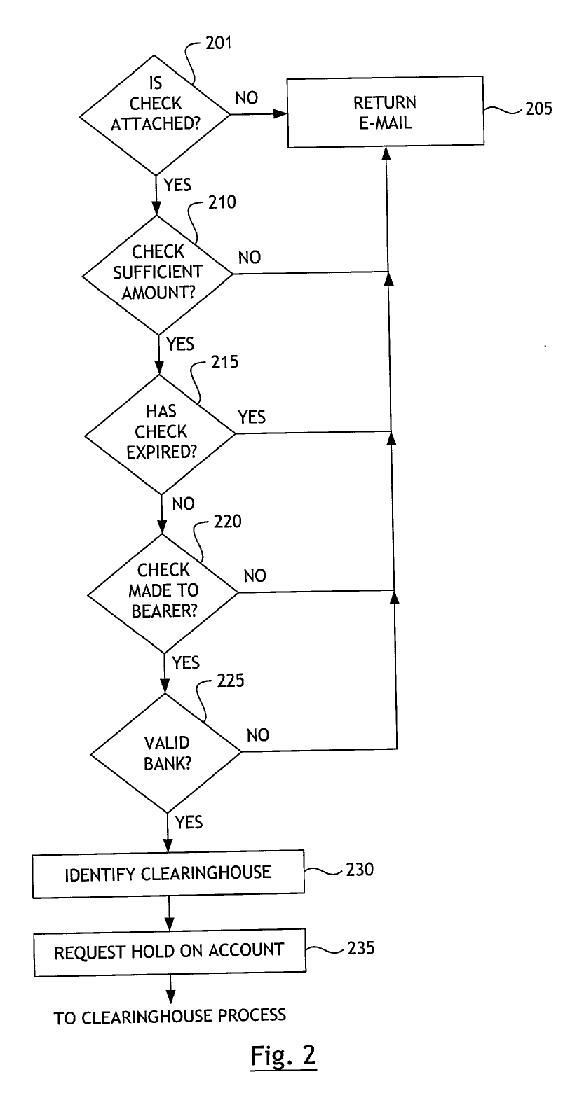

FIG. 2 illustrates the process followed by the recipient's Internet service provider to process the e-mail with the attached check. After the e-mail has left the sender's Internet service provider, it goes through the Internet to the recipient's Internet service provider. The recipient's Internet service provider then determines if the e-mail has a check attached (step 201).

If no check is attached to the e-mail, the Internet service provider marks the e-mail's status as a return to sender for lack of a check and the Internet service provider sends the e-mail back to the sender (step 205). If a check is attached to the e-mail, the check's value is compared to the recipient's minimum required value to determine if the check has sufficient value to allow the e-mail to be forwarded to the recipient (step 210).

If the check does not have sufficient value, the e-mail's status is marked as return to sender due to lack of sufficient check value and the Internet service provider sends the e-mail back to the sender (step 205) (referred to in the art as a “bounced message”).

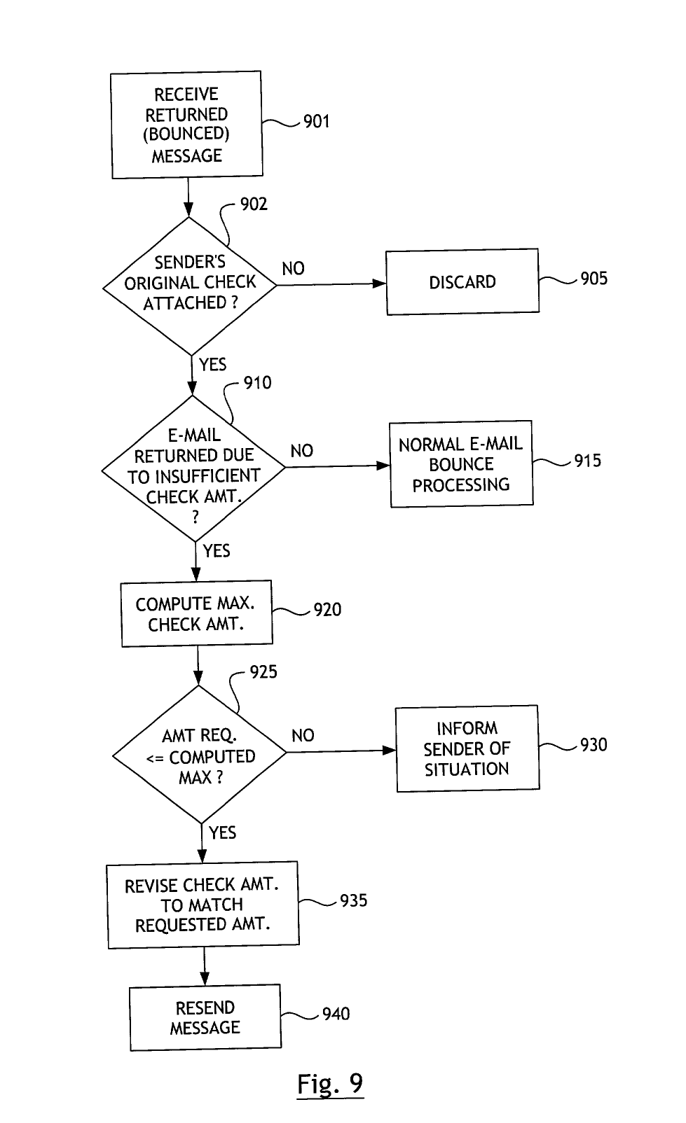

Additionally, the sender's email service provider may optionally provide automatic amount renegotiation in this case, as shown in FIG. 9. The process begins with receipt of a “bounced” message (step 901). Receipt and recognition of “bounced” messages is well known in the art and is not further discussed.

Upon receipt, a determination is made if the message has an included check appropriately signed by the original sender (step 902). If it does not, it is adjudged to be an attempt to by-pass the filtering system and is discarded (step 905). If the bounced message has an included check, a determination is made whether the reason for the bounce was insufficient value of the check (step 910).

In the preferred embodiment, the reason for the bounce is encoded in compliance with IETF RFC 2034 “SMTP Service Extension for Returning Enhanced Error Codes” and would therefore be well known in the art. In the case that the reason for the bounce was other than insufficient value of the attached check, the returned message would be handled by the customary process (step 915).

The maximum value acceptable to the sender is then computed from the priority and addressee of the original message (step 920). In the preferred embodiment, the insufficient value indication on the bounced message would also include an indication of the recipient-required value.

This amount is compared with the computed maximum value acceptable to the sender (step 925). In case the recipient-required amount is more that the sender-acceptable maximum, the system generates a notification to that effect and relays that notification, along with the bounced message, to the sender so that the sender may decide on appropriate action (step 930). In the case that the recipient-required value was less than or equal to the maximum sender-acceptable value, the amount of the check is changed to reflect this agreed-upon value and the check is resigned, changing nothing else about the check (step 935), in particular not the transaction identification number (see below.) This insures that only one of the two checks—the original or the one with the new value—is usable by the recipient, and not both. Following this update, the message is re-sent (step 940) in exactly the same manner as the original transmission (step 110).

Continuing from step 205, if the check has the recipient-required value, the Internet service provider checks to determine if the check has expired (step 215).

In the preferred embodiment, all of the checks of the present invention have an expiration data. This provides the check signer with a date after which he no longer has to worry about having funds or credits to back up the check. For example, if the recipient never cashes the check, the check would continue to be cashable and the signer would have to continue having funds for it until the state law specifies that the check is stale.

If the check has expired, the e-mail's status is marked as return to sender due to an expired check and the Internet service provider sends the e-mail back to the sender (step 205). If the check has a valid date, the Internet service provider determines if the check is made out to the bearer (step 220). As in a paper check, this prevents the holder from cashing a check that was received erroneously or fraudulently. If the check was not made out to the bearer, the e-mail's status is marked as return due to improper bearer name and the Internet service provider sends the e-mail back to the sender (step 205).

If the check was made out to the bearer, it is next determined if the bank is valid (step 225). It may be possible for a check signer to generate a check drawn on a bogus bank. This step provides the recipient with the knowledge that the bank does exist. If the bank is invalid, the e-mail's status is marked as return to sender due to an invalid bank and the Internet service provider sends the e-mail back to the sender (step 205).

If the bank is valid, the clearinghouse to which the check is to be sent is then determined (step 230). In the preferred embodiment, only a limited number of clearinghouses exist in order to provide more control over the checks. The Internet service provider then requests the clearinghouse to place a hold on the signer's account equal to the amount of the check (step 235). In another embodiment, the request is for a hold on the signer's account that is more than the amount of the check in order to provide funds for paying for the transaction. This could be a minimal fee for each transaction initiated by an e-mail incorporating a check.

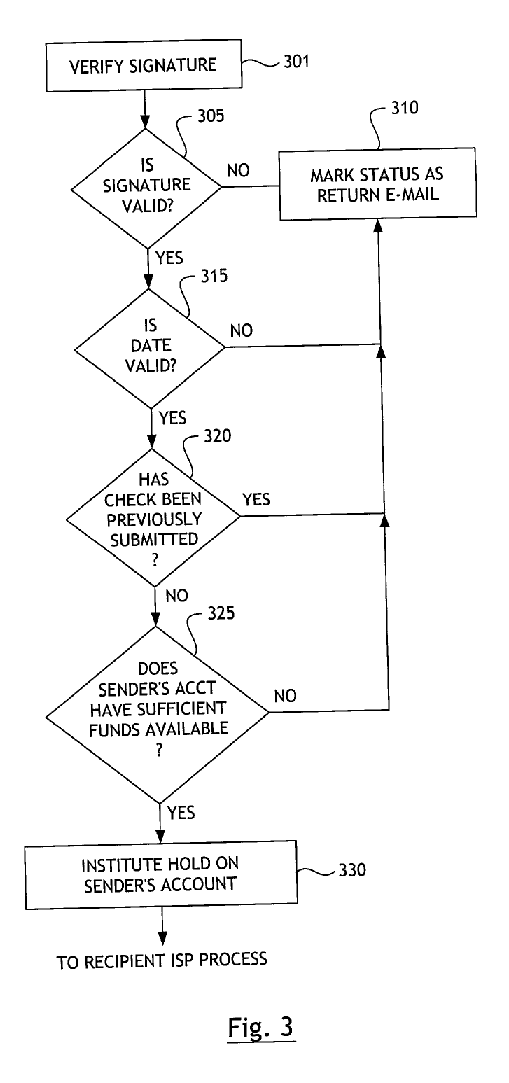

FIG. 3 illustrates the process used by the clearinghouse to process a check of the present invention. The clearinghouse first verifies the signature (301). Since the checks of the present invention are electronic in nature, they will not, in the preferred embodiment, have “signatures” as used on paper checks. A normal signature that is applied to an electronic check would be too easy to forge in order to create a fraudulent check.

The signature used by the processes of the present invention is similar to the “digital keys” or “digital certificates” used by PRETTY GOOD PRIVACY for e-mail encryption or the United States Patent and Trademark Office for electronic filings of patent applications.

One such process for establishing a digital signature is to first verify the identity of the individual through a Notary Public or other such method. That individual is then sent a code to the address of record through the U.S. Postal Service or other letter carrier. The individual is also sent a code through the Internet via e-mail. The individual inputs both of these codes into the program used to generate the digital signature. From that point, whenever the individual selects the “signature” option of the program, such as to sign a check, a code is embedded in the check or e-mail that identifies that person as being the originator.

If the signature is invalid (step 305), the status of the e-mail is marked as return to sender due to invalid signature (step 310). In the preferred embodiment, the clearinghouse does not return the e-mail to the sender. As described subsequently, when the e-mail is sent back to the recipient's Internet service provider for further processing, the Internet service provider reads the status and acts accordingly.

If the signature is determined to be valid (step 305), the clearinghouse determines if the date is valid (step 315). If the date is not valid, the e-mail's status is marked as return to sender due to an invalid date (step 310).

If the date is valid, the clearinghouse determines if the check has been submitted previously (step 320). This is accomplished, in the preferred embodiment, through a unique transaction identification assigned to each check. The transaction identification may be a numeric code, an alphanumeric code, or an alpha code. The identification prevents reuse of the check by either party. The clearinghouse tracks all transaction identifications in a central database available to all clearinghouses. This provides the same information to all clearinghouses so that the recipient or signer cannot go through another clearinghouse to reuse the check.

If the transaction identification is not valid, the e-mail's status is marked as return to sender due to invalid transaction identification (step 310). If the transaction identification is valid, the clearinghouse checks the signer's account to determine that sufficient value exists to cover the amount of the check (step 325). As described above, the value can be monetary, credits, or any other form of value that can be traded.

If the signer's account does not have sufficient value, the e-mail's status is marked as return to sender to due insufficient value (step 310). If the signer's account has sufficient value to cover the check, the clearinghouse institutes a hold on the signer's account that is equal to the amount of the check (step 330).

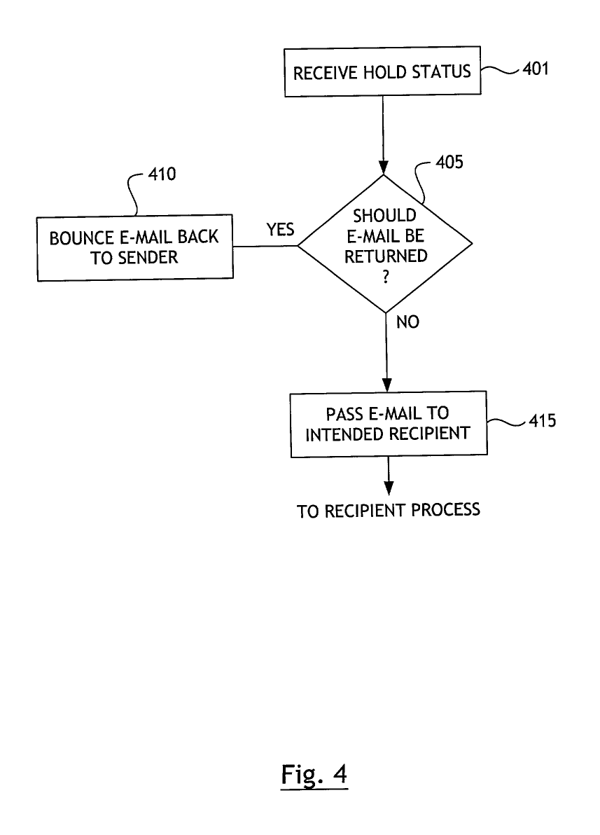

The process then continues with the recipient's Internet service provider receiving the check and e-mail status from the clearinghouse. This process is illustrated in FIG. 4. The Internet service provider receives the hold status from the clearinghouse (step 401). This lets the Internet service provider know whether a hold was successfully placed on the signer's account that is equal to the value of the check.

The Internet service provider then checks the status of the e-mail to determine if it should be sent back to the sender (step 405). If the status indicates that there is a reason to return the e-mail, the Internet service provider sends the e-mail back (step 410). If the e-mail with the attached check survived the process without having a return to sender status assigned, the e-mail is passed on to the intended recipient (step 415).

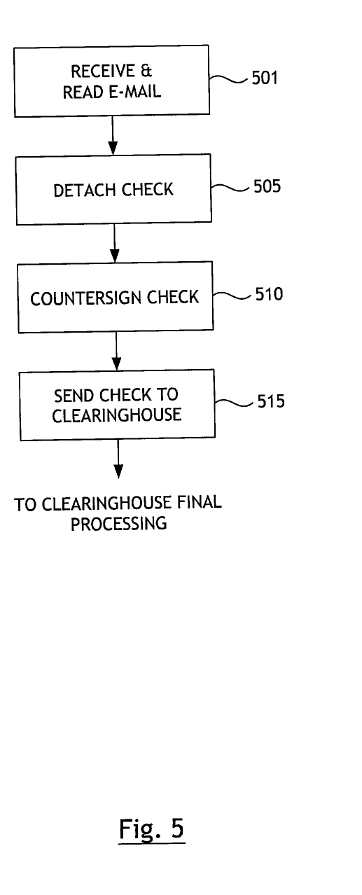

FIG. 5 illustrates the process used by the intended recipient. The recipient first receives and reads the e-mail (step 501). The check for the predetermined value is detached (step 505) and countersigned (step 510) by the intended recipient.

As in the initial signing of the check as described above, the intended recipient “countersigns” by having his digital signature embedded in the check. This provides proof that the intended recipient has received and agreed with the check's value. The recipient then sends the countersigned check back to the same clearinghouse (step 515) through the Internet service provider.

If the intended recipient does not go through the countersigning process, the hold on the sender's account that is equal to the value of the check will be released after the check's validity date has expired. This ensures that the intended recipient does not hold the check for an extended period of time such that the sender does not know whether the check will be cashed or not.

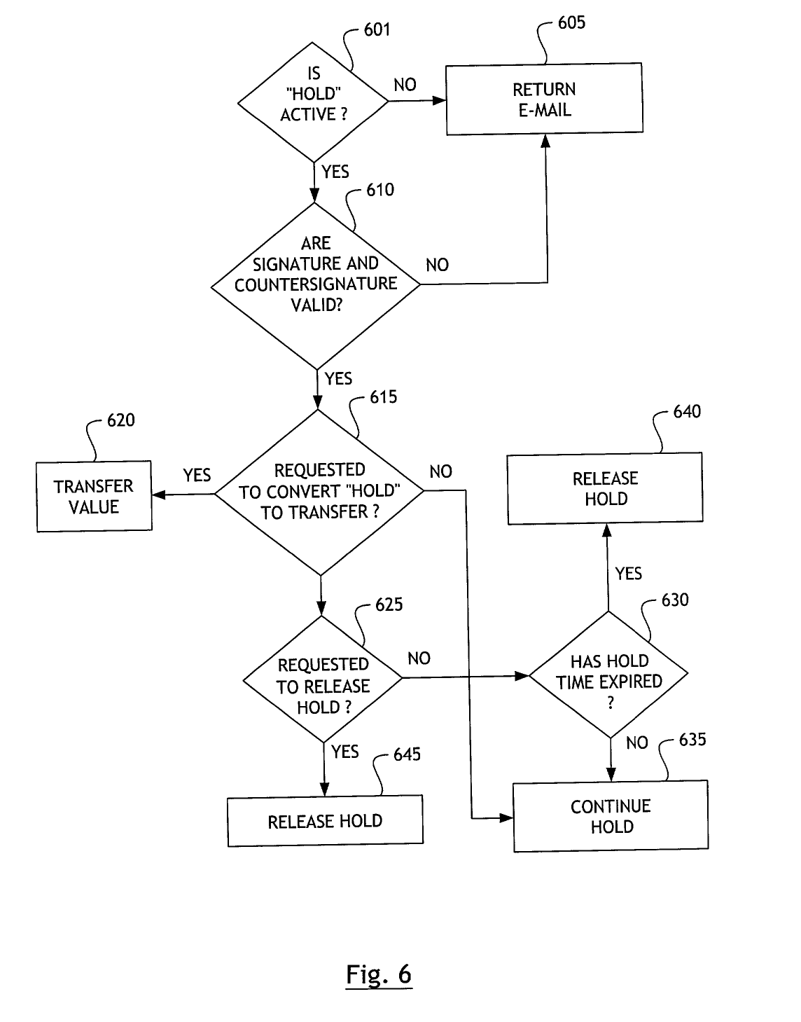

FIG. 6 illustrates the final process used by the clearinghouse to process the countersigned check. The process begins with the clearinghouse determining if the indicated hold is still active (step 601). The intended recipient may have held onto the check for a long time before countersigning and sending back to the clearinghouse. In this case, the hold on the sender's account may have expired. If the hold has expired, the e-mail's status is marked as return to sender due to expired hold period and the e-mail is returned to the sending Internet service provider for return to the sender (step 605).

If the indicated hold is still active, the clearinghouse checks the countersignature for validity (step 601). In the preferred embodiment, the intended recipient's digital signature is kept on file at the clearinghouse for comparison. Alternate embodiments store the recipient's digital signature at the bank or some other central database that is accessible by on the clearinghouse and banks.

If the signature is not valid, the e-mail's status is marked as return to sender due to invalid countersignature and the e-mail is forwarded to the Internet service provider for return to the sender (step 605). If the signature is valid, the clearinghouse determines if the intended recipient has requested that the hold be converted to an actual transfer (step 615) of value.

In the preferred embodiment of the present invention, there is no requirement that the intended recipient actually require the transfer of value from the sender's account. For example, if the friends or family of the recipient desire to send e-mail to the recipient, the recipient would probably not want to charge them. In this case, the recipient would not request that the hold be converted to a transfer of value.

If the hold has been converted to a transfer of value, the clearinghouse performs the transfer to the intended recipient's account (step 620). If the hold has not been converted, the clearinghouse determines if the recipient has requested that the hold be released (step 625). If the recipient has requested the hold release, the clearinghouse releases the hold on the sender's value (645) thereby letting the sender use that value again.

If the recipient has not requested that the hold be released, the clearinghouse checks to see if the hold time has expired (step 630). If the hold time has expired, the hold is released (step 640). If the hold time has not expired, the hold on the sender's value is continued (step 635) until the time expires.

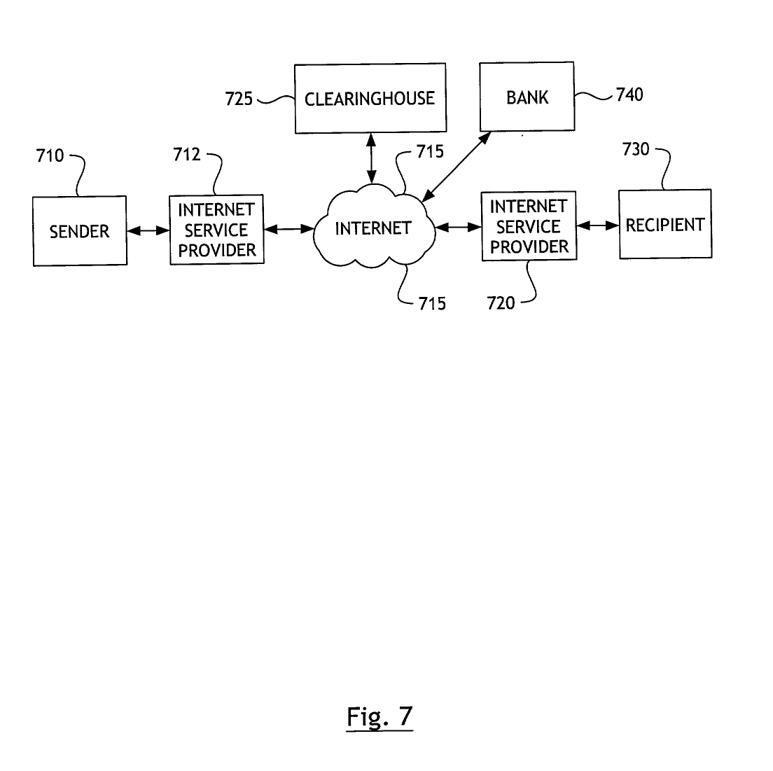

FIG. 7 illustrates a block diagram of the e-mail filtration system of the present invention. The system is comprised of the check signer/sender (710). The sender is coupled to the Internet (715) through an Internet service provider (712). The recipient (730) is also coupled to the Internet (715) through an Internet service provider (720). The recipient and the sender may use the same Internet service provider or different service providers.

The clearinghouse (725) is coupled to the Internet (715) so that it can communicate with the Internet service providers (712 and 720). In an alternate embodiment, the clearinghouse (725) is co-located with one of the Internet service providers (712 or 720).

In the preferred embodiment, the clearinghouse is coupled to a bank (740) through the Internet in order to transfer the funds or value from one account to the other. In another embodiment, the bank (740) is a central database for storage of credits for participants in the attention-based economy. In still another embodiment, the clearinghouse and the bank are the same entity such that access through the Internet is not necessary.

The preferred embodiment of the system of the present invention uses the Internet to couple the blocks of the system. In an alternate embodiment, the Internet is replaced by another network such as an Ethernet network, a Token Ring network, or some other form of packet switched network to perform substantially the same function as the Internet in order to transfer data between the blocks of the system.

There are multiple alternate embodiments of the processes of the present invention. For example, if a non-participant of the attention-based economy sends an e-mail to a participant, the return to sender message sent to the non-participant could include information on how to become a participant.

If a participant sends a check to a non-participant (the check being a “pay to bearer” type), the non-participant's inability to cash the check will cause it to eventually expire without a negative consequence except for the danger that the check will be intercepted by another participant. Within the communities of trust, the participants will continue to include checks to each other, trusting that they will be released or expire, simply because it insures that the sender cannot be faked into spending his valuable time reading a non-solicited e-mail. If the e-mail is a fake, the sender stands to lose the check value.

In the event that a recipient “accidentally” cashes a check, they can redress the problem by replying to the e-mail and including a check for the appropriate amount.

In another embodiment, the recipient's e-mail inbox can be sorted by “check amount”. This gives the recipient the opportunity to read the more valuable e-mails first. Additionally, the e-mail inbox can be sorted by expiration date of the check.

In yet another embodiment, the e-mail service provider functionality and the e-mail client could be augmented so that the sender's check amount can be automatically negotiated and the sender need not participate in the routine selection of the check amount. This could also relieve the recipient and sender from going through the signing, dating, processing, identifying, and attaching the check to an e-mail.

The clearinghouse and Internet service providers can be suitably compensated through a “per transaction” fee. They could also be compensated by a percentage of the cashed check amount. In another embodiment, they are compensated by a monthly service charge.

Using the processes of the present invention, e-mail recipients who are more attractive to advertiser's unsolicited e-mails can set their e-mail admission fees higher without inadvertently blocking people with whom the recipient would like to communicate. By letting the checks from desired individuals expire or the recipient explicitly releasing the hold, the senders will not be charged for e-mailing the recipient.

The processes of the present invention could also be applied to systems other than e-mail, such as telephone and postal mail. For example, in the telephone embodiment, the telephone company could serve as both the service provider and the clearinghouse. The caller would offer a particular amount to be transferred to the recipient's telephone. The telephone company would initiate the transfer based on the recipient's fee preferences. After the telephone call has been completed, the recipient could either cash out the promise for value, with the amount being transferred to the recipient's account, or cancel the transfer. This would deter telemarketers from calling individuals without their permission.

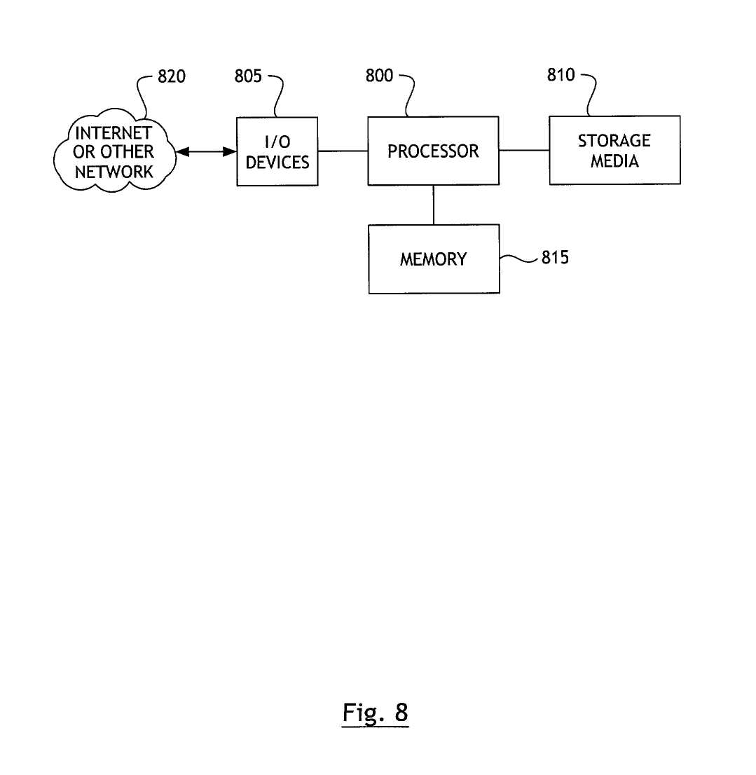

FIG. 8 illustrates a general block diagram of a computer server used by system of FIG. 7. In the preferred embodiment, FIG. 8 is a more detailed diagram of both the clearinghouse and the Internet service provider servers. FIG. 8 illustrates only one embodiment of these systems. Alternate embodiments are comprised of different computers having different functional blocks.

Referring to FIG. 8, the server is comprised of a processor (800) for controlling the server and running the processes of the present invention. The memory (815), coupled to the processor (400), is responsible for temporarily holding data for access by the processor (800) and various computers and mobile devices that are coupled to server over the Internet or other network. Storage media (810), coupled to the processor (800) can include hard drives, floppy drives, and any other media for storing data in a more permanent fashion. This storage media (810), in the preferred embodiment, stores the advertisement pool of the present invention.

The Input/Output (I/O) devices (805) are used to couple the server to the Internet or any other network (820) coupled to the server. The I/O devices (805) include modems, Ethernet cards, and any other devices required to couple the server to a network. The I/O devices (805) also include displays, monitors, keyboards, and other devices required by operators who interact with the server.

Numerous modifications and variations of the present invention are possible in light of the above teachings. It is therefore to be understood that within the scope of the appended claims, the invention may be practiced otherwise than as specifically described herein.

What is claimed is:

1. A method for filtering electronic mail in a system comprising an electronic mail service provider, the method comprising the steps of:
specifying a requirement for a check, having a predetermined value, to be attached to an electronic mail transmitted by a sender to a recipient; and
if the electronic mail comprises the check, accepting the electronic mail in response to the attached check.

2. The method of claim 1 and further comprising the step of requiring the predetermined value to be a predetermined monetary value.

3. The method of claim 1 and further comprising the step of requiring the predetermined value to be a predetermined credit value.

4. The method of claim 1 and further comprising the step of returning the electronic mail to the sender if the check is not attached.

5. The method of claim 1 and further comprising the step of the sender digitally signing the check.

6. The method of claim 1 and further including the step of the recipient digitally countersigning the check.

7. The method of claim 1 and further including the steps of:
the electronic mail service provider sending the electronic mail to a clearinghouse for processing;
the clearinghouse verifying the sender's digital signature and the recipient's digital signature; and
the clearinghouse placing a value hold on an account from which the check is drawn, the value hold being equal to the predetermined value.

8. A method for filtering a communication in a communications system, the method comprising the steps of:
specifying a requirement for a predetermined value to be attached to the communication transmitted by a sender to a recipient; and
if the communication comprises the predetermined value, the recipient evaluating the communication in response to the attached predetermined value.

9. The method of claim 8 wherein the communications system is a telephone system and the communication is a telephone call.

10. The method of claim 8 wherein the communications system is a postal system and the communication is a written communication.

11. A method for filtering an electronic mail in a system comprising an electronic mail service provider and a clearinghouse, the method comprising the steps of:
the electronic mail service provider receiving the electronic mail addressed to a recipient from a sender;
the electronic mail service provider verifying that the electronic mail comprises a check having a value;
the electronic mail service provider requesting the clearinghouse to place a hold on a sender account associated with the check;
the clearinghouse verifying that the check comprises a signature that corresponds to the sender;
the clearinghouse verifying that the sender account has sufficient value equal to or greater than the value of the check;
if the sender account has sufficient value, the clearinghouse instituting the hold on the sender account substantially equal to the value of the check;
the electronic mail service provider receiving a status of the hold; and
the electronic mail service provider processing the electronic mail in response to the status of the hold.

12. The method of claim 11 wherein the predetermined value is negotiated between the sender and the recipient.

13. The method of claim 11 wherein the predetermined value is determined by the recipient and publicized for access by the public.

14. The method of claim 11 and further including the steps of:
if the status of the hold indicates that the hold was not instituted, the electronic mail service provider returning the electronic mail to the sender; and
if the status of the hold indicates that the hold was instituted, the electronic mail service provider sending the electronic mail to the recipient.

15. The method of claim 14 and further including the steps of:
the recipient countersigning the check; and
the recipient transmitting the countersigned check to the clearinghouse.

16. The method of claim 15 and further including the step of the clearinghouse transferring the value of the check from the sender account to a recipient account.

17. A method for filtering an electronic mail in a system comprising an electronic mail service provider, a client electronic mail, and a clearinghouse, the method comprising the steps of:
the electronic mail service provider receiving the electronic mail addressed to a recipient from a sender;
verifying that the electronic mail comprises a check having a predetermined value, a transaction identification, and an expiration date;
verifying that the expiration date is adequate to process the check;
verifying that the recipient can countersign the check;
requesting the clearinghouse to place a hold on a sender account associated with the check;
verifying that the check comprises a signature that corresponds to the sender;
the clearinghouse verifying that the expiration date has not expired;
verifying that the transaction identification is unique;
verifying that the sender account has sufficient value equal to or greater than the value of the check;
if the sender account has sufficient value, the clearinghouse instituting the hold on the sender account substantially equal to the value of the check;
the electronic mail service provider receiving a status of the hold;
if the hold has not been instituted, the electronic mail service provider sending the electronic mail to the sender;
if the hold has been instituted, the electronic mail service provider forwarding the electronic mail to the client electronic mail;
the client electronic mail countersigning the check with a countersignature;
the client electronic mail transmitting the check to the clearinghouse along with a new hold status request;
verifying that the hold is active;
verifying the countersignature;
if the new hold status request indicates a value transfer, transferring value from the sender account to a recipient account; and
if the new hold status request indicates a release of the hold, releasing the hold on the sender account.

18. The method of claim 17 and farther including the step of instituting the hold for a time-limited duration.

19. The method of claim 17 and further including the steps of:
if the countersignature is not valid, transmitting the electronic mail to the sender; and
if the hold is not active; transmitting the electronic mail to the sender.

20. A method for an electronic mail service provider to filter electronic mail in a system comprising an electronic mail client and at least one clearinghouse, the method comprising the steps of:
receiving an electronic mail addressed to an intended recipient;
verifying that the electronic mail comprises a check having a predetermined value and an expiration date, the check being drawn on a sender's account;
verifying that the predetermined value is sufficient for the intended recipient;
verifying that the intended recipient can validly countersign the check;
identifying a clearinghouse of the at least one clearinghouse that can handle the check; and
requesting the clearinghouse to initiate a hold on the sender's account for an amount substantially equal to the predetermined value.

21. The method of claim 20 and further including the steps of:
receiving a status of the hold from the clearinghouse;
if the status of the hold indicates that the hold is inactive, sending the electronic mail to the sender; and
if the status of the hold indicates that the hold is active, sending the electronic mail to the electronic mail client.

22. A method for a clearinghouse to process an electronic mail check, the check comprising a predetermined value, a sender's signature, an expiration date, an intended recipient, and a transaction identification, the check being drawn on a sender's account, the method comprising the steps of:
verifying validity of the sender's signature;
verifying that the expiration date has not expired;
verifying that the transaction identification is unique to that particular check;
verifying that the sender's account has sufficient value to match the check's predetermined value; and
instituting a hold on the sender's account for an amount substantially equal to the predetermined value.

23. The method of claim 22 wherein the step of instituting the hold includes instituting the hold on the sender's account for an amount equal to the predetermined value plus a transaction fee.

24. The method of claim 22 and further including the steps of:
receiving the check from an electronic mail client, associated with the intended recipient, including a countersignature;
receiving a hold status request from the electronic mail client;
verifying that the hold is active;
verifying that the countersignature is valid;
if the hold status request indicates to release the hold, releasing the hold on the sender's account; and
if the hold status request indicates to convert the hold to a transfer of value, transferring value from the sender's account to an account designated by the intended recipient.

25. The method of claim 24 wherein the value transferred from the sender's account is substantially equal to the predetermined value.

26. A method for an electronic mail client to filter received electronic mail from a sender, the method comprising the steps of:
receiving an electronic mail from the sender through an electronic mail service provider, the electronic mail comprising a check having a predetermined value, a sender's signature, and a transaction identification;
detaching the check from the electronic mail;
countersigning the check with a countersignature; and
transmitting the check with the countersignature to a clearinghouse for processing.

27. A system for filtering electronic mail comprising:
a clearinghouse that processes a check that is coupled to an electronic mail that was sent by a sender to an intended recipient, the clearinghouse generating a check status in response to the processing; and
an electronic mail service provider, coupled to the clearinghouse, that transmits the electronic mail to either the intended recipient or back to the sender in response to the check status.

28. The system of claim 27 and further including a bank coupled to the clearinghouse, the clearinghouse having means for accessing a sender account and an intended recipient account in order to transfer value from the sender account to the intended recipient account.

29. The system of claim 28 wherein the clearinghouse, electronic mail service provider, and bank are coupled through the Internet.

30. The system of claim 28 wherein the clearinghouse, electronic mail service provider, and bank are coupled through a packet switched network.

31. A system for processing a check attached to an electronic mail in order to generate interest in reading the electronic mail, the electronic mail transmitted by a sender to an intended recipient, the check having a predetermined value and being drawn on a sender's account and comprising an expiration date and a transaction identification, the system comprising:
means for verifying validity of the sender's signature;
means for verifying that the expiration date has not expired;
means for verifying that the transaction identification is unique to that particular check;
means for verifying that the sender's account has sufficient value to match the check's predetermined value; and
means for instituting a hold on the sender's account for an amount substantially equal to the predetermined value.
